(19) United States
(12) Patent Application Publication
(10) Pub. No.: US 2025/0390693 A1
(43) Pub. Date: Dec. 25, 2025

(54) METHOD FOR REPRESENTING DISPLAY DATA ON A DISPLAY DEVICE, AND DISPLAY DEVICE

(71) Applicant: KWS Computersysteme GmbH, Ettlingen (DE)

(72) Inventor: Jan Koeppen, Straubenhardt (DE)

(21) Appl. No.: 19/068,120

(22) Filed: Mar. 3, 2025

(30) Foreign Application Priority Data
Jun. 25, 2024 (EP) 24184233.5

(51) Int. Cl. G06K 15/02; G06F 3/14

(52) U.S. Cl. CPC G06K 15/1805; G06F 3/14; G06K 15/1809

(57) ABSTRACT

In many instances, information is depicted on screens since this saves paper, and changes may be made quickly and easily. In particular for distributed information, it may be updated centrally, so that in addition to the paper, also time and energy for traveling to the site may be saved. To simplify the playing of content on the display devices provided for this purpose, the invention proposes to connect the display devices via an interface to a data processing device, which addresses the display device via a printer driver. By use of a simple printout, an image to be represented may thus be output on the screen from any desired software having a printing function.

### REFERENCE TO PENDING PRIOR PATENT APPLICATION

This patent application claims benefit of European Patent Application No. 24184233.5, filed Jun. 25, 2024, which patent application is hereby incorporated herein by reference.

### FIELD OF THE INVENTION

The present invention relates to a method for representing display data, stored on a data processing device, on a display device having at least one screen, the display device being in data connection with the data processing device. The invention further relates to such a display device.

### BACKGROUND OF THE INVENTION

In the field of data processing and the display of information, it is common for data processing devices such as computers or servers to be connected to display devices such as monitors or screens in order to represent visual information. Known systems typically include direct connections between the data processing device and the display device, with the data being transferred and represented in real time. These systems often use various types of interfaces, such as HDMI, VGA, or DVI, to enable the data transfer. In many cases, the representation is controlled by specialized software products, so-called graphics drivers, which are installed on the data processing device and provide the display data in a format that can be interpreted by the display device.

According to known technologies, the control of the display data frequently takes place using dedicated applications or drivers that are specifically designed for the particular hardware. These applications offer numerous functions, such as adaptation of the resolution, management of multiple screens, and configuration of display settings. Despite the flexibility and comprehensive functions of these systems, however, there are some limitations. For example, the direct connection between the data processing device and the display device often requires special cables and connections, which limits the flexibility and mobility of the systems. In addition, the installation and configuration of the necessary software may be complex and time-consuming, in particular in environments with multiple display devices or screens.

In particular, with such display devices it is necessary for the particular data processing device to remain switched on and be available at all times.

Despite the considerable advances in the field of data processing and display of information, there is still a need for improved systems that enable a simpler and more flexible connection between data processing devices and display devices. In particular, there is a need for approaches that reduce the complexity of the installation and configuration, and at the same time ensure reliable and efficient transfer and representation of display data. Known systems are often not capable of fully meeting these requirements, resulting in limitations in user-friendliness and functionality.

### SUMMARY OF THE INVENTION

Therefore, the object underlying the present invention is to provide a system that at least partially overcomes the disadvantages of known systems, and that allows a display device to be loaded from any print-capable data processing device.

According to the present disclosure, these objects are achieved by the features of independent claims 1 and 15. Moreover, further advantageous embodiments result from the dependent claims and the description.

In this regard, a method is provided for representing display data, stored on a display device, on a data processing device having at least one screen. The display device is in data connection with the data processing device, which allows seamless communication between the two devices. An essential component of this method is the interface that connects the display device to the data processing device. This interface is controlled by the data processing device via a printer driver, which represents an innovative use of a conventional printer driver in a new context. The printer driver generates a print image, which is stored in a display file in a printer memory. This display file is then transferred to the display device and represented on the screen. The use of a printer driver and a printer memory may help in overcoming the challenge of efficient data transfer and representation by the fact that they utilize existing technologies in a new way. This arrangement may allow faster representation of the display data, since the printer driver has been developed specifically for the rapid and precise generation of print images. The placement of the interface between the data processing device and the display device is crucial, since it plays a key role in the data transfer and ensures that the display data are represented correctly and with high quality on the screen. Storing the print image in a display file in the printer memory also ensures that the data may be buffered and quickly retrieved when needed, which increases the efficiency of the overall system. This technical arrangement may thus meet the challenge of rapid and precise representation of display data on a screen, and offers an innovative approach due to the use of existing printing technologies in a new field of application.

The method for representing display data, stored on a data processing device, on a display device having at least one screen provides that the display device is in data connection with the data processing device. This data connection allows the transfer of display data from the data processing device to the display device, so that the information stored on the data processing device may be displayed on the screen of the display device.

According to one embodiment, in which the display device retrieves the display file from the printer memory and depicts it on the at least one screen of the display device, a specific mechanism of communication between the components is established which improves the efficiency and functionality of the described method. The display device, which is connected to the data processing device via an interface, assumes an active role in retrieving the display file, which previously has been stored by the printer driver in the printer memory. This retrieval process allows the display device to directly access the stored data without the need for a new transfer from the data processing device. This reduces the latency and minimizes the load on the data processing device, since the data processing and the display are decoupled from one another. The display device thus functions not only as a passive receiver, but also as an active participant in the data flow, which increases the flexibility and responsiveness of the system. This results in optimized use of the system resources and an enhanced user experience, since the data may be represented on the screen more quickly and reliably. The described mechanisms of communication between the components contribute to increasing the overall performance of the system and simplifying the interaction between the data processing device and the display device, which is advantageous in particular in environments with high demands on the data processing and representation.

According to a further embodiment described in the dependent claim, new printing on the printer driver, which is associated with the display device, overwrites the display file in the printer memory. Changing the represented print image will thus take place only in the event that a new display file for representation on the screen is present. Up to this point, the represented image does not change in the interim time period. Overwriting the display file in the printer memory also prevents outdated or unnecessary data from remaining in the memory, thereby optimizing the efficiency and the capacity of the memory. Ultimately, it is necessary only to keep in the display device a memory having the size of one display file.

In a first configuration, the display device may retrieve the display file from the printer memory at regular intervals. The regular retrieval ensures that the display device always displays the most recent data. The display device does not constantly have to be in receive mode if it is sufficient to retrieve the update in the predetermined cycle. The data processing device only has to generate the print image and store it in the display file in the printer memory, while the display device takes on the task of retrieving and displaying this file at regular intervals.

An alternative configuration may provide that the display device has an additional display memory into which the display file is loaded from the printer memory. This enhancement yields several advantages, in particular with regard to the efficiency and flexibility of the data processing and representation. The additional display memory allows the display device to locally store the display file, which reduces the dependency on the continuous connection to the data processing device. This may be particularly useful in scenarios in which the connection is unstable or intermittent, since the display device can continue to display the stored data even if the connection is temporarily interrupted. Even if the display device is switched off occasionally, it can access the data after being restarted, so that even with an interrupted connection it is always provided with a print image. Conversely, the display device must still communicate regularly in order to determine whether a new print image is to be represented, and whether a new display file is present in the printer memory.

According to a further embodiment that encompasses the features of the dependent claims, the display file may have multiple pages, wherein the multiple pages of the display file are represented one after the other on the at least one screen of the display device. The functionality of the method for representing display data is thus significantly expanded. This is particularly useful in scenarios in which extensive data or complex documents which do not fit on a single page must be displayed. This multipage display file is then transferred to the display device, which represents the pages one after the other on the screen. This requires coordinated control by the display device to ensure that the pages are displayed in the correct order and with suitable transitions and in a suitable time interval. The representation of multiple pages one after the other on the screen of the display device yields the advantage that the user obtains a continuous and coherent view of the entire document without having to manually switch between various files or screens. This also allows use of smaller screens to provide more information. Furthermore, this function allows more dynamic and interactive use of the display device, since the user, by use of an appropriate button on the display device, may even actively scroll through the pages, similarly as for a physical document.

A display duration of the representation and/or a run mode with regard to the order are/is preferably stored in the display device and/or predefinable in the printer driver. The adjustability of the display duration of the representation allows definition of the time period during which the display data remain visible on the screen of the display device. This may either be stored directly in the display device and set there, for example via a controller or a button, or predefined by the printer driver and stored directly in the display file. The run mode with regard to the order allows determination of a specific sequence of the display data to be represented. Initially the display may be played forward or backward, which raises the question of how much play remains until all pages have been shown. When the last page is reached, the process may begin once more with the first page, or the sequence may be run through in reverse order. This mode likewise may either be stored in the display device or predefined by the printer driver. Storing these parameters in the display device offers the advantage that the representation may be controlled by the current observer, independently of the data processing device, which allows greater autonomy and flexibility of the display device. On the other hand, predefining these parameters by the printer driver offers the advantage that control is centralized and possibly easier to update, since changes need be made only in the printer driver, and not in each individual display device. In addition, the display devices are thus simpler and less vulnerable, and have less access surface, for example in public areas.

In one specific embodiment, the printer driver may provide multiple printing trays, which allows differentiated, flexible management of the display data. These printing trays function as virtual memory areas within the printer memory, and are specifically configured to operate different connected display devices or screen areas of a display device. Each printing tray may be assigned to a display device from a group of multiple connected display devices, which means that within a printing operation, the printer driver is able to send data in a targeted manner to various display devices. This allows parallel and independent representation of the print image on various display devices, which increases the efficiency and flexibility of the system. In addition, in each case a printing tray may be assigned to multiple screens of a display device, which is particularly useful when a display device has multiple screens and they are to be controlled in the same way. In this case, the display data may be managed in such a way that they are synchronized or distributed specifically over the various screens in order to ensure a coherent and optimized representation. A further feature is that multiple printing trays may be assigned to different areas of a screen of a display device. This allows even finer control of the display data, in that various areas of an individual screen may be controlled independently of one another. This function is particularly advantageous for complex display scenarios in which different pieces of information must be represented, simultaneously and clearly separate, on a single screen, wherein the update rate may also be different.

According to a further embodiment, it may be provided that the interface is a parallel interface or a serial interface, in particular a Universal Serial Bus interface. This specific embodiment of the interface yields several technical advantages and innovations. A parallel interface allows the simultaneous transfer of multiple bits, which may result in a higher data transfer rate. This is particularly advantageous when large data volumes, such as high-resolution print images, are to be quickly and efficiently transferred from the data processing device to the display device. In contrast, a serial interface, in particular a Universal Serial Bus (USB) interface, offers a flexible and widely used approach for the connection between various devices. The USB standard is known for its high data transfer rate, ease of use, and wide compatibility with numerous devices and operating systems. Use of USB as a serial interface significantly simplifies the installation and configuration of the connection between the data processing device and the display device. In addition, the USB standard allows power to be supplied to the display device directly via the interface, which reduces the need for additional power cables and power supply units. This contributes to simplification of the hardware architecture and reduction in overall costs. Furthermore, the USB standard offers the option of connecting multiple devices in a chain, which increases the expandability and flexibility of the system. The selection of a parallel or serial interface gives users the option to choose the connection technology that is best suited to their specific requirements and applications. As a whole, these novel features result in improved performance, user-friendliness, and flexibility of the method for representing display data, in that they allow a fast, reliable, and simple connection between the data processing device and the display device.

Alternatively or additionally, the interface that connects the display device to the data processing device may also be a network interface that is operated either in the local network or on the internet. This means that the communication between the data processing device and the display device is not limited to a direct physical connection, and instead may take place via a network protocol, which significantly increases the flexibility and range of the application. Due to the use of a network interface, the display device may be operated regardless of the physical proximity to the data processing device, which is advantageous in particular in distributed systems or for the remote display of data. In addition, the display device includes at least one communication means that is used to retrieve the display file from the network interface. This communication means may be a network adapter or a WLAN module, for example, that is able to retrieve the display file, stored in the printer memory of the data processing device, via the network protocol. The retrieval of the display file preferably takes place via a targeted request to the display device, which allows efficient and targeted data transfer. These novel features yield several advantages. First, the flexibility of the system is increased, since the connection via a network protocol allows a greater spatial separation between the devices. Second, the scalability is improved, since multiple display devices may access the same data processing device via the network without the need for additional physical connections. Third, maintenance and updating of the system are simplified, since changes or upgrades to the data processing device may be made centrally without the need for physical adaptations at the display devices and with a distributed listing, similarly to bus schedules within a line network. Lastly, the use of network interfaces and communication means allows better integration into existing IT infrastructures, thus reducing the implementation costs and the integration effort. These features thus contribute significantly to improving the functionality and efficiency of the described method.

It may be further provided that the printer driver is a virtual printer driver. A virtual printer driver is a software component that emulates the functionality of a physical driver, but generates no physical print output. Instead, the print image, which normally would be sent to a physical printer, is converted to a digital file. This display file is then stored in the printer memory of the data processing device and subsequently transferred to the display device, where, directly or after a retrieval in its display memory, it is represented on the screen. In addition, the virtual printer driver facilitates the integration into existing software environments, since it behaves like a conventional printer driver and thus may be used by any application that supports printing functions. This results in increased compatibility and user-friendliness.

According to a further embodiment, it may be provided that the interface is a wireless interface. This wireless interface allows cordless communication between the data processing device and the display device, resulting in increased flexibility and mobility of the device arrangement. Implementing a wireless interface eliminates the need for physical cable connections, which not only reduces the installation effort but also increases user-friendliness, since the devices can communicate with one another regardless of their physical position relative to one another. This wireless communication may be achieved using various technologies such as Wi-Fi, Bluetooth, or other wireless transmission protocols that ensure stable and rapid data transfer. The wireless interface is controlled by the data processing device via a printer driver, which generates a print image and stores it in a display file in a printer memory. This display file is then transferred wirelessly to the display device and represented on the screen of the display device. The wireless transfer of the display file offers the advantage that the data may be transferred in real time or essentially in real time, which is particularly advantageous in scenarios with frequently changing display data. In addition, the wireless connection provides the option to control multiple display devices simultaneously and without additional cabling, which increases the scalability of the system. Only a power supply is thus necessary.

In one particularly preferred embodiment, the screen may be an ePaper screen. This specific embodiment yields several advantages and technical effects which significantly improve the functionality and efficiency of the described method for representing display data on a display device. An ePaper screen, also known as electronic paper or eInk display, is characterized by its capability of displaying an image even without a continuous power supply, resulting in much lower energy consumption compared to conventional LCD or LED screens. This is particularly advantageous for applications in which the display device is to be operated over extended time periods without the need for frequent charging or a continuous power grid connection. In addition, an ePaper screen provides excellent readability under various light conditions, including direct sunlight, which expands the possible applications of the display device in different environments.

The communication between the data processing device and the display device via the specified interface and the printer driver remains unchanged in this embodiment; however, the print image generated by the printer driver is now represented on an ePaper screen. This means that the display file, which is stored in the printer memory and transferred to the display device, may be optimized specifically for representation on an ePaper screen. This could encompass, for example, adjustments in the resolution or in the contrast in order to make full use of the advantages of the ePaper technology. The use of an ePaper screen could also prolong the service life of the display device, since these screens are less susceptible to burn-in effects and other signs of wear that may occur with conventional screens. In particular for applications in which still images are to be displayed over extended time periods before a change takes place, an ePaper screen may be used in a particularly meaningful and effective way.

In summary, the use of an ePaper screen as a display device in the described method results in significant improvements with regard to energy efficiency, readability, and longevity without the need for changes to the basic communication structure between the components. This represents a very particularly advantageous refinement of the original method, which could be of great interest in particular for applications in the field of mobile and energy self-sufficient display devices.

Lastly, the display file may be an image file, a text file, preferably in PDF format, or an HTML file. The flexibility and compatibility of the system are increased significantly by the definition of the display file as an image file, text file, PDF file, or HTML file. Image files allow the representation of graphic content in high quality, which is particularly advantageous for applications with visual requirements. Text files offer a simple and efficient option of representing text-based information which is easy to process and search. Use of the PDF format yields additional advantageous, since PDF files are platform-independent and ensure consistent representation on various devices. PDFs are also widely used, and support numerous types of content, including text, images and vector graphics, which makes them a versatile format for the display file. HTML files allow the representation of content that is interactive and dynamic, which is particularly important for web applications and internet-based content. With the support from HTML files, the display device may also represent content that originates from the internet or that is used by web-based technologies. This variety of file formats ensures that the system may be used in various fields of application and for different requirements.

The above-described invention is explained in greater detail below with reference to one exemplary embodiment.

### BRIEF DESCRIPTION OF THE DRAWINGS

In the figure:

FIG. 1 shows a schematic illustration of a system for representing display data, stored on a data processing device, on a display device. The data processing device is connected via an interface to a printer driver, which generates a print image and stores it in a display file in a printer memory. This display file is then transferred to the display device and represented on its screen.

### DETAILED DESCRIPTION OF THE PREFERRED EMBODIMENTS

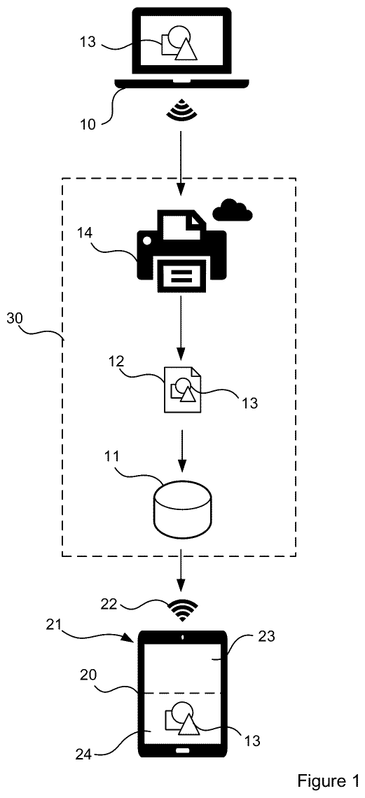

FIG. 1 shows a schematic illustration of a system for representing display data, stored on a data processing device 10, on a display device 20, together with at least one screen 23. The data processing device 10 is connected to the display device 20 via an interface 30. The interface 30 is controlled by the data processing device 10 via a printer driver 14.

The data processing device 10 first generates a print image 13, a bus schedule, for example, by means of the printer driver 14. Each display device 20 that is provided in the system and connected to the data processing device 10 has its own printer driver 14, so that, starting from the data processing device 10, each display device 20 may be chosen by making a selection in the print dialog of the data processing device 10. Within the print dialog, it is then possible to choose an area 24, similar to the way that a paper cassette is selected in a printer. Staying with the image of the bus schedule, this may be, for example, an advertisement in an area 24 of the screen 23 which may also change fairly frequently. To achieve such a change, multipage printing may be carried out; in this case the display device 20 outputs the pages one after the other, wherein a time period that is predefinable as a parameter or settable on the device elapses before an image change takes place.

The print image 13 is now stored in a display file 12 that is present in a printer memory 11. The display file 12 is subsequently transferred to the display device 20 via the interface 30. The display device 20 retrieves the display file 12 from the printer memory 11 and represents the print image 13 on the screen 23. The display device 20 may retrieve the display file 12 from the printer memory 11 at regular intervals to ensure that the most current version of the display file 12 is always represented.

The display device 20 has an additional display memory 21 into which the display file 12 is loaded. In this way, even after the display device 20 is restarted and when the data processing device is no longer intended to be reachable, the display file 12 may be reloaded and the desired print image 13 may once again be represented, without further communication to the outside. However, the display device 20 receives a message from the printer driver 14 as needed when a new display file 12 is present in the printer memory 11. This allows automatic updating of the displayed data.

The interface 30 may include a parallel interface or a serial interface, in particular a Universal Serial Bus interface. Alternatively, the interface 30 may be a network interface, which is wireless if necessary, in the local network or on the internet, wherein the display device 20 includes at least one communication means 22 for retrieving the display file 12 from the network interface. In particular for a bus schedule that is posted at the various bus stops of a line, the display devices 20 are situated far apart from one another, so that it is a major advantage to load the display device 20 remotely.

The screen 23 of the display device 20 may be an ePaper screen, which displays the image with clear readability over an extended time period, even without a further power supply. The display file 12 may be an image file, a text file, preferably in PDF format, or an HTML file.

A method and a display device are thus described above which allow a screen to be loaded with a print image from any desired print-capable application.

### LIST OF REFERENCE NUMERALS

10 data processing device
11 printer memory
12 display file
13 print image
14 printer driver
20 display device
21 display memory
22 communication means
23 screen
24 area
30 interface

What is claimed is:

1. A method for representing display data, stored on a data processing device (10), on a display device (20) having at least one screen (23), the display device (20) being in data connection with the data processing device (10),
characterized in that the display device (20) is connected to the data processing device (10) via an interface (30), wherein the interface (30) is controlled by the data processing device (10) via a printer driver (14), and a print image (13) that is generated by the printer driver (14) is stored in a display file (12) in a printer memory (11), and this display file is transferred to the display device (20) and represented on the at least one screen (23) of the display device (20).

2. The method according to claim 1,
characterized in that the display device (20) retrieves the display file (12) from the printer memory (11) and depicts it on the at least one screen (23) of the display device (20).

3. The method according to claim 2,
characterized in that new printing on the printer driver (14), which is associated with the display device (20), overwrites the display file (12) in the printer memory (11).

4. The method according to claim 1,
characterized in that the display device (20) retrieves the display file (12) from the printer memory (11) at regular intervals.

5. The method according to claim 1,
characterized in that the display device (20) has an additional display memory (21) into which the display file (12) is loaded, wherein the display device (20) receives a message from the printer driver (14) when a new display file (12) is present in the printer memory (11).

6. The method according to claim 1,
characterized in that the display file (12) may have multiple pages, wherein the multiple pages of the display file (12) are represented one after the other on the at least one screen (23) of the display device (20).

7. The method according to claim 6,
characterized in that a display duration of the representation and/or a run mode with regard to the order are/is stored in the display device (20) and/or predefinable in the printer driver (14).

8. The method according to claim 1,
characterized in that the printer driver (14) provides multiple printing trays, wherein each printing tray is assigned to a display device (20) from a group of multiple connected display devices and/or multiple screens of a display device (20) and/or multiple areas of a screen (23) of a display device (20).

9. The method according to claim 1,
characterized in that the interface (30) is a parallel interface or a serial interface, in particular a Universal Serial Bus interface.

10. The method according to claim 1,
characterized in that the interface (30) is a network interface in the local network or on the internet, wherein the display device (20) includes at least one communication means (22) for retrieving the display file (12) from the network interface.

11. The method according to claim 10,
characterized in that the printer driver (14) is a virtual printer driver.

12. The method according to claim 1,
characterized in that the interface (30) is a wireless interface.

13. The method according to claim 1,
characterized in that the screen (23) is an ePaper screen.

14. The method according to claim 1,
characterized in that the display file (12) is an image file, a text file, preferably in PDF format, or an HTML file.

15. A display device having a housing with at least one screen (23) for representing display data, and an interface (30) for data connection to a data processing device (10), characterized in that the display device (20) is connected to the data processing device (10) via an interface (30) which is controllable via a printer driver (14) of the data processing device (10), and has a display memory (21) in which a print image (13) generated by the printer driver (14) is storable in a display file (12) and is representable on the at least one screen (23).

16. The display device according to claim 15,
characterized in that a parallel or serial interface or a network interface is associated with the housing.

17. The display device according to claim 15,
characterized in that the screen is an ePaper screen.
